(19) United States
(12) Patent Application Publication
(10) Pub. No.: US 2003/0050366 A1
(43) Pub. Date: Mar. 13, 2003

(54) Acrylic polymer compositions

(76) Inventors: Fabio Giberti, Paderno Dugnano (IT); Andrea Anghileri, Milano (IT); Simona Bigi, Milano (IT); Umberto Moschetti, Rho (IT)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/182,672

(22) PCT Filed: Jan. 29, 2001
(86) PCT No.: PCT/EP01/00869

(30) Foreign Application Priority Data
Feb. 1, 2000 (IT) MI2000A000143

(51) Int. Cl. C08L 1/00; C08L 33/04; C08K 7/16

(52) U.S. Cl. 523/223; 523/221; 525/222

(57) ABSTRACT

Compositions of acrylic polymers comprising: A) from 70% to 99.5% by weight of a thermoplastic resin based on homopolymers or copolymers formed by monomers containing only one double bond polymerizable by radical route, of which at least 20% by weight are (meth)acrylic monomers, B) from 0.5% to 30% by weight of a preferably crosslinked elastomer having an on-set glass transition temperature (Tg) lower than 0° C., in said composition the component B) being dispersed in the resin A) under the form of spherical and/or elongated particles having a diameter in the range of about 10 nm-2,000 nm, the particles of component B) optionally including particles of component A).

The present invention relates to flexible acrylic polymer based compositions, i.e. having an improved elongtaion at break and the process for their preparation.

More specifically the compositions of the invention show mechanical properties, in particular elastic modulus and ageing resistance (resistance to UV rays), thermal properties and optionally also optical properties in transparent materials, comparable with the corresponding ones of the acrylic (co)-polymer materials, but having an improved elongation at break which can even be superior of about one magnitude order.

It is known in the prior art that there are materials based on acrylic polymers having good mechanical properties, specifically flexibility or elongation at break. More specifically they are materials prepared with compositions based on acrylic polymers having impact-resistant properties, as for example described in EP 270,865, U.S. Pat. No. 3,985,703. These flexible materials, in particular those described in said EP, are obtained by mixing to the acrylic (co)polymers an impact-resistant additive in an amount equal to or higher than 20% by weight. These impact-resistant additives of the prior art have the drawback that the obtained resins show a lower elastic modulus in comparison with the materials solely formed by acrylic (co)polymers. Compounds used as impact-resistant additives are for example core-shell emulsions having a resin core, an intermediate layer of acrylic rubber and an outer layer of (meth)acrylic resin. The core can be for example formed by a crosslinked acrylic polymer and the intermediate layer is formed by a crosslinked elastomer copolymer having a Tg lower than 25° C., preferably lower than −10° C.; the outer layer is formed by a (meth)acrylic resin grafted to the rubber.

The materials obtained by acrylic (co)polymers containing impact-resistant additives have lower optical properties compared with those of the acrylic (co)polymers. For example a typical composition of impact-resistant acrylic polymers is as follows:

a) 40-95% by weight of a thermoplastic resin formed by acrylic polymers,

b) 60-5% by weight of a polymer having a multilayer structure comprising:

5-60% by weight of a core of thermoplastic acrylic resin as defined in a),

20-50% by weight of a first layer, which surrounds the core, formed by a crosslinked elastomer formed by butyl acrylate/styrene 85/15.

13-35% by weight of an acrylic resin forming the outer layer.

According to the prior art, as impact-resistant additives of the acrylic (co)polymers it is possible to use elastomers having a very low Tg and therefore having improved mechanical properties. In this way in the compounding phase it would be theoretically possible to use amounts of additive lower than the above mentioned 20% limit. Examples of said additives are those formed by core-shell emulsions, similar in the structure to that of the above described additive, but having instead of the elastomer a butadiene (co)polymer, or SBR resins (cross-linked styrene/butadiene copolymers). However also the mixtures of these additives with the acrylic (co)polymers worsen the optical properties and the light-resistance of the starting materials: generally an increase of the opacity of these mixtures proportionally to the difference between the refractive indexes of the continuous acrylic phase and of the dispersed elastomeric phase takes place. The articles obtained using the mixtures of the above mentioned additives with the acrylic (co)polymers, as said, are not very resistant to UV radiations, wherefore they become opaque and brittle if exposed to the sunlight for long periods.

The need was therefore felt to have available compositions based on acrylic (co)polymers having the following advantages with respect to the prior art compositions as mentioned below:

with respect to the acrylic (co)polymer materials, comparable optical, light resistance and abrasion resistance properties but with an improved elongation at break,

with respect to the acrylic (co)polymer compositions with impact-resistant additives, lower modulus loss, the elongation at break being equal.

It has now been unexpectedly and surprisingly found that it is possible to obtain acrylic polymer compositions having the above mentioned combinations of properties.

An object of the present invention are acrylic polymer compositions comprising:

A) from 70% to 99.5% by weight, preferably from 80% to 99%, still more preferably from 90% to 98% by weight, of a thermoplastic resin based on homopolymers or copolymers formed by monomers containing only one double bond polymerizable by radical route, wherein at least 20% by weight, preferably at least 50%, are (meth)acrylic monomers,

B) from 0.5% to 30% by weight, preferably from 1% to 20%, still more preferably from 2% to 10% by weight of an elastomer, preferably crosslinked, having an on-set glass transition temperature (Tg) (ASTM D 3418-75) lower than 0° C., preferably lower than −5° C., still more preferably lower than −10° C.,

in said composition the component B) being dispersed in the resin A) under the form of spherical and/or elongated particles, the particle B) diameter, determined by electronic microscopy (TEM transmission electronic microscopy), in the range of about 10 nm-2,000 nm, in the case of elongated particles the diameter being that of a transversal section perpendicular to the main axis, the particles of component B) optionally including particles of component A).

Preferably the particles of component B), can include component A). In this case the particles of component B) have sizes generally in the range 300 nm-2,000 nm and the particles of component A) included in B) have a diameter, determined as above mentioned, generally lower than 200 nm.

Generally the compositions of the invention are preferably obtainable by extrusion. Said compositions can be in the form of granules or semifinished articles, for example flat plates, pipes and sections bars. Granules have well known sizes generally from 1 to 7 mm, the shapes are those well known, for examples cylindrical, lenticular shapes.

The monomer or the (co)monomer mixture usable for the component A) containing one double bond polymerizable by radical route, are for example (meth)acrylic acids or their alkyl or hydroxyalkyl esters, wherein the alkyl radical has from 1 to 8 carbon atoms, or their amides. For example (meth)acrylic acid, methyl(meth)acrylate, ethyl(meth)acrylate, propyl(meth) acrylate, isopropyl(meth)acrylate, butyl(meth)acrylate, secbutyl(meth)acrylate, ter-butyl(meth)acrylate, hydroxyethyl(meth)acrylate, hydroxypropyl(meth)acrylate, (meth)acrylammide can be mentioned. Also a mixture of these monomers can be used.

To the monomer of component A) or to the mixture of the (co)monomers of component A) another monomer having only one double bond polymerizable by radical route can be optionally added, in an amount generally not higher than 80% by weight, preferably not higher than 50%, such as for example styrene, alpha-methyl-styrene, (meth)acrylonitrile, N-alkyl or N-aryl-maleimides, respectively having the alkyl from 1 to 10 carbon atoms and the aryl from 6 to 12 carbon atoms.

The preferred acrylic (co)polymers of the component A) are those containing at least 70% by weight of methylmethacrylate, such as PMMA and the copolymers of methylmethacrylate with (meth)acrylic acids or their esters, preferably ethyl or methyl or butyl acrylate or (meth)acrylic acid.

Examples of preferred elastomers to be used as component B), provided that they satisfy the above mentioned Tg, are those obtainable by polymerizing one or more (co)monomers selected from the following groups:

acrylic acid esters wherein the alkyl group has from 1 to 16 carbon atoms, preferably from 2 to 12 carbon atoms, such as ethyl acrylate, propyl acrylate, isopropyl acrylate, n-butyl acrylate, isobutyl acrylate, 2-ethyl-hexyl acrylate, etc.,

alkoxy-alkyl acrylates, wherein the total number of the carbon atoms of the alkyl group and the alkoxyl group is in the range 2-16, preferably 3-15; such as for example 2methoxyethyl acrylate,

monomers having double ethylene unsaturation for example butadiene or substituted butadiene such as for example isoprene, chloroprene, 2-3 dimethylbutadiene,

vinyl monomers, for example styrene and its derivatives, such as for example methyl- and ethyl-styrene, wherein the alkyl group is in ortho or para position; alpha methylstyrenes; mono-, di-, tri-, tetra-, penta-halogenstyrenes, wherein the halogen is Cl, F, said monomers being in an amount not higher than 40% by weight, prefe-rably not higher than 30% by weight based on the total of the monomers of component B).

The preferred elastomer as component B) is the butyl- or 2-ethylhexyl or octyl acrylate copolymer containing styrene in an amount in the range 5-30% by weight, preferably 10-20%.

When the component B) is crosslinked, to favour the crosslinking of component B) during the polymerization, it can optionally contain crosslinking comonomers containing at least two double bonds, in amounts in the range 0-2%, preferably 0-1% by weight referred to the amount of the monomers of component B). Examples of these comonomers are allyl (meth)acrylate, diallyl maleate, diallyl phthalate, diallyl fumarate, triallyl cyanurate, ethylenglycol di(meth)acrylate, di-, tri-, tetra-ethylenglycol di(meth)acrylate, 1,3-1,4-butylenglycol di(meth)acrylate, divinylbenzene, trivinylbenzene, etc.

The comonomers used for crosslinking can, after plymerization, still have some double bond unreacted.

In order to increase the crosslinking degree among the elastomeric B) chain after polymerization and during the obtainment of granules or semifinished articles, for example in the extrusion phase, to the component B) crosslinking monomers containing a functional group of polar type can be added in polymerization as cure-site, in an amount in the range 0-2% by weight based on the total of the monomers of component B). Examples of these monomers are (meth)acrylic acid, glycidyl (meth)acrylate, (meth)acrylamide.

Depending on the monomers forming the elastomer, crosslinking can be carried out without addition of crosslinking monomer, if comonomers of B) comprise acrylic esters, wherein the alkyl has a number of carbon atoms higher than or equal to 4, preferably C₄-C₁₀, for example butyl acrylate, 2-ethylhexyl acrylate, n-octyl acrylate.

If the polymer material obtained with the composition according to the present invention must be transparent, the monomer composition of elastomr B) must be selected so that the elastomer has a refractive index in the range 98-102%, preferably 99-101% with respect to that of the thermoplastic resin A).

Preferably the refractive indexes of the two components A) and B) are equal.

It is another object of the present invention compositions obtainable by compounding the above mentioned compositions of the invention with thermoplastic polymers known in the prior art, equal to or different from the thermoplastic resin of component A), such as for example polymethylmethacrylates, such as for example Altuglas®, vinyl polychloride, acrylic polymers, styrene polymers, polybutylenterephthalate PBT or polyethylenterephthalate PET, polycarbonates PC, polyamides, with the proviso that the percentage of elastomer B) in the so obtained compositions is in the range of about 0.5% and about 30% by weight, preferably of about 1% and about 20% by weight, still more preferably of about 2% and about 10% by weight with respect to the total of the composition. In this case the beads obtained by polymerization formed by components A) and B) are compounded in admixture with said thermoplastic polymers.

Preferably compounding is made by extrusion.

The compositions of the invention can be prepared by the following process.

Another object of the invention is a process for preparing the compositions of the invention comprising a polymerization process in suspension for the formation of beads and subsequent compounding of the so obtained beads.

The suspension process for obtaining beads comprises at least the following steps:

1) preparation of beads of elastomer B) by a polymerization process in suspension of the monomers, optionally in the presence of at least a crosslinking monomer as above defined;

2) polymerization, in the same polymerization suspension containing the formed beads of elastomer B) obtained in step 1), of the (co)monomers forming the thermoplastic polymer A), said (co)monomers selected from those above mentioned.

The thermoplastic resin of component A) of the composition of the invention which is produced in the second step, can be grafted on the elastomer component B) if among the elastomer monomers there are monomers such as for example the above mentioned acrylic acid esters wherein the alkyl has a number of carbon atoms equal to or higher than 4, or crosslinking monomers containing at least two double bonds.

A preferred process for the polymerization in suspension, preferably aqueous suspension, of the invention monomers of components A) and B), is carried out in the presence of a radical initiator soluble in the monomers and of a suspending agent for stabilizing the suspension. For example inorganic or organic suspending agents can be mentioned. Among the latter, polymeric organic compounds, such as polyvinylalcohol, acrylic copolymers containing a (meth)acrylic acid, carboxymethylcellulose etc. can be mentioned.

As preferred suspending agents the following are mentioned:

homopolymers of a compound of formula

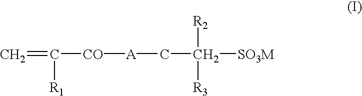

wherein R₁=H or CH₃; R₂ and R₃, equal or different, are H or C₁-C₈ alkyls optionally branched when possible; M is an alkaline or alkaline-earth metal or ammonium and A is NH, oxygen or NCH₃.

copolymers of the compound of formula I with acrylic monomers in an amount not higher than 40% by weight.

Generally the suspending agent amount is in the range 0.1-1.5%, preferably 0.2-1% by weight, referred to the total weight of the aqueous phase.

Preferably the aqueous polymerization phase is at least partially formed by mother liquors obtained by a polymerization suspension process of a monomer polymerizable by radical route, preferably an acrylic monomer, even different from those used in the process.

By mother liquors obtained by a polymerization process in aqueous suspension it is meant the aqueous phase which remains after separation of the (co)polymer beads, which is for example carried out by centrifugation or filtration.

Said aqueous phase, or polymerization mother liquors contains in suspension an organic phase formed by the suspending agent and by polymer compounds present under the form of particles having a diameter lower than 15 microns, not separable by the methods usually employed to recover the polymerization product. The organic phase amount can be determined by weight as dry residue, evaporating a small aliquot of mother liquors, for example an amount of about 10 g, at the temperature of 160° C. until a completely dry residue is obtained. Said residue is generally in the range 0.05-5% by weight, preferably 0.05-1.5%.

The part of acrylic polymer in the residue is determined by extracting the residue with acetone, by evaporating the solvent and determining the dry product weight. By difference the amount of suspending agent is determined.

Therefore the mother liquors contain a reduced amount of organic compounds and are mainly formed by water.

The polymerization suspension is optionally added with fresh suspending agent, in order to obtain a total concentration of this component in the range 0.05-1% by weight, preferably 0.15-0.8% by weight.

In the aqueous suspension polymerization for the preparation of B) (step 1) of the process), one operates with ratios between the aqueous phase and monomers generally in the range 1.5:1-20:1 by weight, preferably 2:1-10:1 by weight, in the presence of a radical polymerization initiator soluble in the monomer. One can operate without a chain transfer agent. The reaction temperatures are those at which the initiator decomposes and are generally in the range 50-120° C.

In the aqueous suspension polymerization for the preparation of A) (step 2) of the process), one operates with ratios between the aqueous phase and monomers generally in the range 1:1-10:1 by weight, preferably 1.4:1-6:1 by weight, in the presence of a chain transfer agent and a radical polymerization initiator, both selected among those soluble in the monomer. The reaction temperatures are those at which the initiator decomposes, and are generally in the range 50° C.-120° C.

As radical initiators, peroxides such as for example di-benzoylperoxide, t-butylperoxydiethyl acetate or unstable azocompounds, such as for example azodiisobutyronitrile can be mentioned.

As chain transfer agents, alkylthiols can be used with the linear or branched C₃-C₂₀ alkyl group, preferably C₄-C₁₂, such as for example n-butanthiol, n-octanthiol, n-dodecanthiol, ter-dodecanthiol, cyclohexanthiol, pinanthiol.

The preferred suspending agents of formula (I) or their copolymers with acrylic monomers are described in the patent application EP 457,356 herein incorporated by reference. In particular the compounds of formula (I) can be, for example, 2-(meth)acrylamido-2-methylpropansulphonate of sodium, 2-acrylamidopropansulphonate of sodium, 2-acrylamido-2-ethan-sulphonate of sodium.

The acrylic monomers which can be copolymerized with the compounds of formula (I) can be, for example, (meth)acryl-amide, alkaline or alkaline-earth salts of the (meth)acrylic acid, (meth)acrylic acid esters with a C₁-C₄ aliphatic alcohol, acrylonitrile.

Other suspending agents which can be mentioned are polyvinyl alcohol, hydroxyalkylcelluloses, homo- and copolymers of poly(meth)acrylic acids containing at least 60% of (meth)-acrylic acid, polyvinylsulphonic acid, etc.

The beads obtained with the above described suspension polymerization process, after washing with water and drying, are compounded, preferably by extrusion, for obtaining granules or plates or semifinished articles having the composition according to the present invention.

The beads obtained with the above described polymerization process, as said, can optionally be compounded, for example extruded, in admixture with thermoplastic polymers such as for example polymethacrylates and polyvinylchloride, with the proviso that the percentage of elastomer B) in the final mixture is, the above mentioned one.

The invention compositions, as said, have an improved elongation at break. However these compositions do not show a good impact-resistance.

The invention compositions can be made impact-resistant by addition of known impact-resistant additives. Surprisingly and unexpectedly the obtained impact-resistant properties are superior to those which should be obtained on the basis of the known impact-reistant additive.

It has moreover been unexpectedly and surprisingly found by the Applicant that compositions obtained by compounding, preferably by extrusion, the compositions according to the present invention as above defined with known impact-resistant additives give improved impact-resistant compositions. These compositions can be obtained also starting from the beads of the compositions of the invention obtained in polymerization, mixed with known impact-resistant additive and subsequent compounding, for example extrusion. The above obtained impact-resistant compositions can be added to thermoplastic resins, then compounding, for example extrusion, obtaining thermoplastic resins with improved impact-resistant properties. This result is quite surprising and unexpected since the impact-resistant properties are superior also with respect to the compositions of thermoplastic resins containing equal or higher amounts of known impact-resistant additive.

The impact-resistant composition according to the present invention comprises an amount of known impact-resistant additive in the range 10-50% by weight, preferably 15-45% by weight, the remaining part is formed by the composition according to the present invention comprising the components A) and B), optionally added with one or more thermoplastic polymers of the prior art, provided that the elastomer B) in the remaining part is in the range 0.5-30% by weight, preferably 1-20%, still more preferably 2-10% by weight. Any known impact-resistant additive can be used. Preferably known impact-resistant additives having a core/shell structure are used. By core/shell structure, it is meant a structure wherein an elastomer particle is covered by a grafted resin layer which acts as compatiblizing agent between the particle and the matrix containing the particle. Said elastomer particle can, optionally, contain a thermoplastic resin core, in which there can optionally be an elastomer core.

As thermoplastic polymers which can be used with the above mentioned impact-resistant compositions, acrylic polymers, PVC, styrene polymers, polybutylenterephthalate PBT or polyethylenterephthalate PET, polycarbonates PC, polyamides, etc., can be used.

A preferred method for obtaining thermoplastic resins having impact-resistant properties consists in carrying out the compounding only once. One mixes:

the beads obtained by polymerization in suspension of the compositions of the invention,

the known impact-resistant additive,

the thermoplastic resin,

then compoundization follows preferably by extrusion.

Some illustrative but not limitative examples are reported hereinafter.

### EXAMPLE 1

Preparation of the Suspending Agent

In a reactor 120 parts of a NaOH solution at 40% by weight and 630 parts of deionized water are introduced. 250 parts of 2-acrylamido-2-methylpropansulphonic acid (AMPS) are slowly fed and the pH is regulated in the range 7-8 with small additions of soda or AMPS. After having fluxed the solution with nitrogen to eliminate oxygen, it is heated to 50° C.

When the solution reaches this temperature, potassium persulphate 0.075 parts and sodium methabisulphite 0.025 parts are added in sequence. After about 60 minutes the polymerization reaction is over. Then the solution is diluted with about 4,000 parts of deionized water obtaining a solution with a dry residue of 5.5% by weight at 160° C., and a Brookfield viscosity of 4 Pa.s, determined at 25° C.

### EXAMPLE 2 (COMPARATIVE)

Preparation of the Mother Liquors and of the Acrylic Copolymer According to the Prior Art: Polymerization in Suspension of Methylmethacrylate and of Ethyl Acrylate by Using as Suspending Agent the Solution Containing the Homopolymer of the Sodium Salt of the 2-acrylamido-2-methylpropansulphonic Acid Prepared According to Example 1

In a pressure-sealed reactor, equipped with stirrer and outer jacket, 193 parts of deionized water and 7 parts of the solution obtained in Example 1, corresponding to 0.2 parts of suspending agent, are introduced. The oxygen is removed by nitrogen flow and the solution is heated to 80° C. Then 100 parts of a cold deoxygenated mixture by nitrogen flow are fed, which is formed by 96 parts of methylmethacrylate, 4 parts of ethyl acrylate, 0.25 parts of t-butylperoxy-2-ethylhexanoate, 0.12 parts of n-butanthiol. The reactor is hermetically sealed, pressurized at 50 KPa with nitrogen and, under continuous stirring, the mixture is gradually heated up to 110° C. in 120 minutes. The temperature is maintained at 110° C. for 15′ and then it is cooled.

The composition of the obtained resin is the following: methylmethacrylate 96%, ethyl acrylate 4%.

The polymer beads are separated from the mother liquors by centrifugation, washed with deionized water and dried in stove.

The mother liquors, containing a dry residue of about 0.6%, formed for 0.2% by the suspending agent and for the remaining fraction by the acrylic polymer under the form of particles in emulsion, are collected to be used again in the subsequent tests.

The beads are extruded under the form of grains with a tween-screw extruder at 250° C. and the extruded product is molded by injection, obtaining a transparent material having the following characteristics:

Flexural elastic modulus: 3,250 MPa (ISO 178).

Tensile yield strain: 73 MPa (ISO R 527).

Tensile elongation at break: 3% (ISO R 527).

Light transmittance at room temperature on a specimen having 3 mm thickness: 92% (ASTM D 1003).

Haze at room temperature on a specimen having 3 mm thickness: 1.5% (ASTM D 1003).

“Colour reversal”: absent.

The determination is carried out as follows. One piece of the molded product is directly observed at the sunlight by rotating. The “color reversal” phenomenon occurs when the piece, depending on how it is rotated, colours with blue or yellow tones.

Dumb-bell specimens (ISO 294, 3167) are injection molded and submitted to elastic modulus (ISO 178), elongation at break (ISO R 527), charpy unnotched (ISO 179/1fU) and to charpy notched (ISO 179/1eA) determination.

The characterization results are reported in Table 1 and in Table 2.

### EXAMPLE 3

Preparation of a Composition of Acrylic Polymers According to the Present Invention Containing 80% of Component A) and 20% of Component B)

Step 1) Polymerization in Suspension of Butyl Acrylate and Styrene (Component B)), by Using as Aqueous Suspending Solution the Mother Liquors coming from the Polymerization Described in Example 2, Added with Fresh Suspending Agent

In the reactor 196 parts of mother liquors of Example 2 together with 4 parts of the solution obtained in Example 1, are fed, obtaining a solution having 0.7% of dry residue (suspending agent+polymer contained in the mother liquors). The solution is heated to 80° C. and 20 parts of an organic mixture, cold deoxygenated by nitrogen flow, formed by 81.6 parts of butyl acrylate, 18.4 parts of styrene, 0.25 parts of t-butylperoxy-2-ethylhexanoate, are fed.

The polymerization is carried out according to the methods described in Example 2.

Step 2) Polymerization in Suspension of Methylmethacrylate and Ethyl Acrylate (Component A))

80 parts of an organic mixture, cold deoxygenated by nitrogen flow, formed by 96 parts of methylmethacrylate, 4 parts of ethyl acrylate, 0.25 parts of t-butylperoxy-2-ethyl-hexanoate, 0.12 parts of n-butanthiol are fed in the suspension in which the polymerization of B) has been carried out.

The polymerization is carried out according to the methods described in Example 2.

The polymer is separated from the mother liquors by centrifugation under the form of beads, which are washed with deionized water and dried in stove.

The obtained beads have the following composition:

80% by weight of component A), formed by methyl methacrylate and ethyl acrylate in a weight ratio 96/4.

20% by weight of component B), formed by butyl acrylate/styrene in a weight ratio 82/18.

### EXAMPLE 3a

Preparation of a Composition of Acrylic Polymers According to the Present Invention Containing 95% of Component A) and 5% of Component B)

Step 1) Polymerization in Suspension of Butyl Acrylate and Styrene (component B)), by Using as Aqueous Suspending Solution the Mother Liquors Coming from the Polymerization Described in Example 2, Added with Fresh Suspending Agent

In the reactor 196 parts of mother liquors of Example 2 together with 4 parts of the solution obtained in Example 1, are fed, obtaining a solution with 0.7% of dry residue (suspending agent+polymer contained in the mother liquors). The solution is heated to 80° C. and 5 parts of an organic mixture, cold deoxygenated by nitrogen flow, formed by 81.6 parts of butyl acrylate, 18.4 parts of styrene, 0.25 parts of t-butyl-peroxy-2-ethylhexanoate are fed.

The polymerization is carried out according to the procedures described in Example 2.

The product obtained at the end of the polymerization is not soluble in chloroform, but it swells in this solvent reaching a volume 10 times greater than the initial one.

This indicates that the product has a low crosslinking degree.

Step 2) Polymerization in Suspension of Methylmethacrylate and Ethyl Acrylate (Component A))

95 parts of an organic mixture, cold deoxygenated by nitrogen flow, formed by 96 parts of methylmethacrylate, 4 parts of ethyl acrylate, 0.25 parts of t-butylperoxy-2-ethyl-hexanoate, 0.12 parts of n-butanthiol are fed in the suspension in which the polymerization of B) has been carried out.

The polymerization is carried out according to the procedures described in Example 2.

The polymer beads are separated from the mother liquors by centrifugation, washed with deionized water and dried in stove.

The obtained beads have the following composition:

95% by weight of component A), formed by methyl methacrylate and ethyl acrylate in a weight ratio 96/4.

5% by weight of component B), formed by butyl acrylate/styrene in a weight ratio 82/18.

The beads are extruded under the form of grains with a twin-screw extruder at 250° C.

Dumb-bell specimens (ISO 294, 3167) are injection molded and submitted to elastic modulus (ISO 178), elongation at break (ISO R 527), charpy unnotched (ISO 179/1fU) and charpy notched (ISO 179/1eA) determination.

The results are reported in Table 1 and in Table 2.

One sample is cut with a tool capable to cut strips having a thickness lower than 10 micron. The so obtained specimen is treated with osmium tetroxide for preparing it to the electronic microscope examination and morphologically distinguish the elastomer component B) from the thermoplastic resin A). At the electronic microscope it is noticed that the thermoplastic resin forms the continuous phase, in which the elastomer particles having both the spherical and elongated shape are dispersed. The elongated particles have the transversal section diameter perpendicular to the greater axis of the particle in the range 10-2,000 nm. Furthermore in the elastomer particles having larger sizes, in the range 300-400 nm-2,000 nm, included resin particles are observed having a diameter in the range 50-100 nm.

### EXAMPLE 3b

Preparation of a Composition of Acrylic Polymers According to the Present Invention Containing 80% of Component A) and 20% of Component B)

Step 1) Polymerization in Suspension of Butyl Acrylate and Styrene (component B)), by Using as Aqueous Suspending Solution the Solution Containing the Sodium Salt Homopolymer of the 2-acrylamido-2-methylpropansulphonic Acid Prepared According to Example 1.

In the reactor 184 parts of deionized water and 16 parts of the solution obtained in Example 1, corresponding to 0.4 parts of suspending agent, are fed. The solution is heated to 80° C. and 20 parts of an organic mixture, cold deoxygenated by nitrogen flow, formed by 81.6 parts of butyl acrylate, 18.4 parts of styrene, 0.25 parts of t-butylperoxy-2-ethylhexanoate, are fed.

The polymerization is carried out according to the procedures described in Example 2.

Step 2) Polymerization in Suspension of Methylmethacrylate and Ethyl Acrylate (Component A))

80 parts of an organic mixture, cold deoxygenazed by nitrogen flow, formed by 96 parts of methylmethacrylate, 4 parts of ethyl acrylate, 0.25 parts of t-butylperoxy-2-ethylhexanoate, 0.12 parts of n-butanthiol are fed in the suspension in which the polymerization of B) has been carried out.

The polymerization is carried out according to the procedures described in Example 2.

The polymer beads are separated from the mother liquors by centrifugation, washed with deionized water and dried in stove.

The obtained beads have the following composition:

80% by weight of component A), formed by methyl methacrylate and ethyl acrylate in a weight ratio 96/4.

20% by weight of component B), formed by butyl acrylate/styrene in a weight ratio 82/18.

The elastomer component B) contains as comonomer the ester of the acrylic acid butyl acrylate. Then the polymer chains of the thermoplastic resin are grafted to the elastomer core. This is shown by measuring the methylmethacrylate amount which remains attached to the component B) after removal of the component A) from beads. The analysis is carried out with the following procedures.

An amount of beads equal to 10 g, corresponding to 2 g of component B), is dipped in about 200 ml of acetone. The suspension is maintained under stirring for 2-3 hours. Under these conditions the thermoplastic resin is solubilized while the elastomer is insoluble in the solvent. It is filtered, the solid is washed with acetone and dried in stove at 70-80° C. to remove the solvent. The sample analysis is effected by NMR. The methylmethacrylate amount of component A) which is linked to the elastomer B) is equal 1.5% by weight with respect to the weight of component B), or to 0.3% by weight of the bead as such (component A+B).

### EXAMPLE 4

25 parts by weight of beads obtained in Example 3 are mixed with 75 parts by weight of acrylic resin obtained in Example 2, and extruded under the form of grains with a twin-screw extruder at 250° C.

The obtained product has the following composition:

95% by weight of component A), formed by methyl methacrylate and ethyl acrylate in a weight ratio 96/4.

5% by weight of component B), formed by butyl acrylate/styrene in a weight ratio 82/18.

Dumb-bell specimens (ISO 294, 3167) are injection molded and submitted to elastic modulus (ISO 178), elongation at break (ISO R 527), charpy unnotched (ISO 179/1fU) and charpy notched (ISO 179/1eA) determination.

The results are reported in Table 1 and in Table 2.

One sample is cut with a tool capable to cut strips having a thickness lower than 10 micron. The so obtained specimen is treated with osmium tetroxide for preparing it to the electronic microscope examination in order to distinguish the elastomer component B) from the thermoplastic resin A). At the electronic microscope it is noticed that the thermoplastic resin forms the continuous phase, in which the elastomer particles having both the spherical and elongated shape are dispersed. The elongated particles have the transversal section diameter perpendicular to the particle greater axis in the range 10-2,000 nm. Furthermore in the elastomer particles having larger sizes, with a diameter in the range 300-400 nm-2,000 nm, included resin particles are observed having a diameter in the range 50-100 nm.

### EXAMPLE 5

10 parts by weight of beads obtained in Example 3 are mixed with 90 parts by weight of acrylic resin obtained in Example 2, and extruded under the form of grains with a twin-screw extruder at 250° C.

The obtained product has the following composition:

98% by weight of component A), formed by methyl methacrylate and ethyl acrylate in a weight ratio 96/4.

2% by weight of component B), formed by butyl acrylate/styrene in a weight ratio 82/18.

Dumb-bell specimens (ISO 294, 3167) are injection molded and submitted to elastic modulus (ISO 178) and elongation at break (ISO R 527) determination.

The results are reported in Table 1.

One sample is cut with a tool capable to cut strips having a thickness lower than 10 micron. The so obtained specimen is treated with osmium tetroxide for preparing it to the electronic microscope examination in order to distinguish the elastomer component B) from the thermoplastic resin A). At the electronic microscope it is noticed that the thermoplastic resin forms the continuous phase, in which the elastomer particles having both the spherical and elongated shape are dispersed. The elongated particles have the transversal section diameter perpendicular to the particle greater axis in the range 10-2,000 nm.

### EXAMPLE 6

5 parts by weight of beads obtained in Example 3 are mixed with 95 parts by weight of acrylic resin obtained in Example 2, and extruded under the form of grains with a twin-screw extruder at 250° C.

The obtained product has the following composition:

99% by weight of component A), formed by methyl methacrylate and ethyl acrylate in a weight ratio 96/4.

1% by weight of component B), formed by butyl acrylate/styrene in a weight ratio 82/18.

Dumb-bell specimens (ISO 294, 3167) are injection molded and submotted to elastic modulus (ISO 178) and elongation at break (ISO R 527) determination.

The results are reported in Table 1.

One sample is cut with a tool capable to cut strips having a thickness lower than 10 micron. The so obtained specimen is treated with osmium tetroxide for preparing it to the electronic microscope examination in order to distinguish the elastomer component B) from the thermoplastic resin A). At the electronic microscope it is noticed that the thermoplastic resin forms the continuous phase, in which the elastomer particles having both the spherical and elongated shape are dispersed. The elongated particles have the transversal section diameter perpendicular to the particle greater axis in the range 10-2,000 nm.

### EXAMPLE 7 (COMPARATIVE)

8.9 kg of the acrylic thermoplastic resin obtained in Example 2 are mixed with 1.1 kg of acrylic impact-resistant additive (MPD) according to the prior art, prepared according to Example 20 (col. 17) of U.S.Pat. No. -A-3,793,402.

The ratio by weight between the two components thermoplastic resin/MPD is 89/11. It is extruded in the form of grains with a twin-screw extruder at 250° C., obtaining the impact-resistant thermoplastic resin according to the prior art.

Dumb-bell specimens (ISO 294, 3167) are injection molded and submitted to elastic modulus (ISO 178) and elongation at break (ISO R 527) determination.

The results are reported in Table 1.

### EXAMPLE 8 (COMPARATIVE)

5.8 kg of the thermoplastic resin obtained in Example 2 are mixed with 4.2 kg of acrylic impact-resistant additive (MPD) according to the prior art, prepared according to Example 20 (col. 17) of U.S. Pat. No. -3,793,402.

The ratio by weight between the two components thermoplastic resin/MPD is 58/42. It is extruded under the form of grains with a twin-screw extruder at 250° C., obtaining the impact-resistant thermoplastic resin according to the prior art.

Dumb-bell specimens (ISO 294, 3167) are injection molded and submitted to elastic modulus (ISO 178) and elongation at break (ISO R 527) determination.

### EXAMPLE 9 (COMPARATIVE)

8.5 kg of the thermoplastic resin obtained in Example 2 are mixed with 1.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 85/15.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 10 (comparative)

7.5 kg of the thermoplastic resin obtained in Example 2 are mixed with 2.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 75/25.

It is extruded under the form of grains with a tween-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 11 (COMPARATIVE)

6.5 kg of the thermoplastic resin obtained in Example 2 are mixed with 3.5 kg of impact-resistant acrylic additive (MPD) according to the prior art, prepared according to Example 20 (col. 17) of USP-A-3,793,402.

The ratio by weight between the two components thermoplastic resin/additive is 65/35.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 12

8.5 kg of the mixture according to the invention under the form of beads obtained in Example 3a are mixed with 1.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 85/15.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 13

7.5 kg of the mixture according to the invention under the form of beads obtained in Example 3a are mixed with 2.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 75/25.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 14

6.5 kg of the mixture according to the invention under the form of beads obtained in Example 3a are mixed with 3.5 kg of impact-resistant acrylic additive (MPD) according to the prior art, prepared according to Example 20 (col. 17) of USP-A-3,793,402.

The ratio by weight between the two components thermoplastic resin/additive is 65/35.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 15

8.5 kg of the mixture under the form of extruded grains obtained in Example 4 are mixed with 1.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 85/15.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 16

7.5 kg of the mixture under the form of extruded grains obtained in Example 4 are mixed with 2.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 75/25.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 17

6.5 kg of the mixture under the form of extruded grains obtained in Example 4 are mixed with 3.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 65/35.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 18

25 parts by weight of beads obtained in Example 3b are mixed with 75 parts by weight of acrylic resin obtained in Example 2, and extruded under the form of grains with a twin-screw extruder at 250° C.

The obtained product has the following composition:

95% by weight of component A), formed by methyl methacrylate and ethyl acrylate in a weight ratio 96/4.

5% by weight of component B), formed by butyl acrylate/styrene in a weight ratio 82/18.

Dumb-bell specimens (ISO 294, 3167) are injection molded and submitted to elastic modulus (ISO 178), elongation at break (ISO R 527), charpy unnotched (ISO 179/1fU) and charpy notched (ISO 179/1eA) determination.

The results are reported in Table 1 and Table 2.

One sample is cut with a tool capable to cut strips having a thickness lower than 10 micron. The so obtained specimen is treated with osmium tetroxide for preparing it to the electronic microscope examination in order to distinguish the elastomer component B) from the thermoplastic resin A). At the electronic microscope it is noticed that the thermoplastic resin forms the continuous phase, in which the elastomer particles having both the spherical and elongated shape are dispersed. The elongated particles have the transversal section diameter perpendicular to the particle greater axis in the range 10-2,000 nm. Furthermore in the elastomer particles having larger sizes, having a diameter in the range 300-400 nm-2,000 nm, resin included particles having a diameter of the order of 50-100 nm, are noticed.

### EXAMPLE 19

8.5 kg of the mixture under the form of extruded grains obtained in Example 18 are mixed with 1.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 85/15.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 20

7.5 kg of the mixture under the form of extruded grains obtained in Example 18 are mixed with 2.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 75/25.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

### EXAMPLE 21

6.5 kg of the mixture under the form of extruded grains obtained in Example 18 are mixed with 3.5 kg of impact-resistant acrylic additive (MPD) according to the prior art, prepared according to Example 20 (col. 17) of U.S. Pat. No. -A-3,793,402.

The ratio by weight between the two components thermoplastic resin/additive is 65/35.

It is extruded under the form of grains with a twin-screw extruder at 250° C.

Dumb-bell specimens (ISO 294, 3167) are injection molded and submitted to elastic modulus (ISO 178), charpy unnotched (ISO 179/1fU) and charpy notched (ISO 179/1eA) determination. The results are reported in Table 2.

Comment to the Data of Table 1.

Table 1 shows that the material prepared with the composition according to the present invention (Examples 3a, 4, 5, 6 and 18) substantially maintains the elastic modulus of the thermoplastic acrylic material (Example 2) but the elongation at break is greater.

The mechanical properties of the compositions obtained according to Examples 3a, 4 and 18 which contain the same amount of elastomer B), are practically equal, even though the compositions are obtained, as from the Examples, in a different way.

Furthermore the Table shows that by mixing in the ratio 58:42 by weight (comparative Example 8) the thermoplastic resin according to Example 2 with a conventional impact-resistant additive (MPD), the modulus value decreases of about 60% of that of the acrylic material of Example 2, the one of the elongation at break of about 20% with respect to that obtained with the mixtures of Examples 3a, 4 or 18 according to the present invention, which contain an amount of elastomer B) equal to 5% by weight based on the total of the resin.

If in the composition the impact-resistant additive amount is reduced in order to increase the material flexural modulus, as in the comparative Example 7 (impact-resistant additive MPD amount 11% by weight), it is noticed that the elongation at break decreases in a percentage equal to about 80% with respect to that obtained with the compositions of Examples 3a, 4 and 18 according to the present invention, which contain an even higher amount of acrylic copolymer with respect to the composition of the comparative Example 7.

Comment to the data of Table 2.

Table 2 shows that the elastic modulus of the material prepared with the composition according to the present invention, in admixture with the impact-resistant additives prepared according to the prior art (Examples 12, 13 and 14) or in admixture with the impact-resistant additives and thermoplastic resins of the prior art (Examples 15, 16, 17, 19, 20 and 21), the impact-resistant additive amount being equal, is substantially equal to the elastic modulus of the material obtained by extruding a thermoplastic acrylic resin with the same impact-resistant additive (ref. comparative Examples 9, 10 and 11).

The impact-resistance properties (charpy notched and unnotched) of the compositions according to the present invention are clearly higher.

The comparative Example 11 shows that by mixing in the ratio 65/35 by weight the thermoplastic resin of the prior art obtained according to Example 2, with a conventional impact-resistant additive (MPD) the modulus decreases to a value which is about 38% with respect to that of the thermoplastic resin of Example 2, but the impact-resistance (charpy notched) increases of 186%.

Example 13 shows that by mixing the composition according to the invention with an amount of the same impact-resistant additive (MPF) (composition/MPD ratio 75:25) lower than that used in the comparative Example 11, both the flexural elastic modulus (the difference with respect to that of the thermoplastic resin of Example 2 decreasees to 26%), and the impact-resistance (charpy notched) increase.

Example 14 shows that by mixing the composition according to the invention with the same amount of the same impact-resistant additive (MPD) used in the comparative Example 11, the same reduction of the modulus value (38%) as in the comparative Example 11 is obtained, but the impact-resistance (charpy notched) is higher.

Table 2 shows also that the invention compositions obtained according to the following Examples:

12, 15 and 19;

13, 16 and 20;

14, 17 and 21;

which contain the same fraction by weight of impact-resistant additive (MPD) and the same percentage by weight of elastomer but which have been prepared in a different way, have mechanical properties (flexural modulus, charpy notched, charpy unnotched) practically equal.

These results confirm that the mechanical properties of the compositions according to the present invention are independent from the preparation method, but that depend on the present amount of elastomer component B) and on that of impact-resistnat additive (MPD).

TABLE 1
Mechanical properties determined on injection-molded dumb-
bell specimens (ISO 294, 3167), obtained by grains prepared
by extrusion of the compositions shown in the Table

| | Composition | Flexural | Tensile | Elongation |
|---|---|---|---|---|
| | ratios and % by weight | modulus | yield | at break |
| Ex. | Mix = mixture | MPa | MPa | % |
| 2_{comp} | Acrylic thermoplastic | 3250 | 73 | 3 |
| | resin (comparative) | | | |
| | Compositions according | | | |
| | to the invention | | | |
| 3a | comp. A)/B) 95/5 | 2960 | 67 | 52 |
| 18 | comp. A)/B) 95/5 | 2950 | 66 | 51 |
| | Resin according to the | | | |
| | invention | | | |
| | A) + B) + acrylic | | | |
| | resin | | | |
| 4 | Mix Ex. 3/Ex. 2 | 2950 | 67 | 50 |
| | Comp. B) 5% | | | |
| 5 | Mix Ex. 3/Ex. 2 | 3080 | 71 | 11 |
| | comp. B) 2% | | | |
| 6 | Mix Ex. 3/Ex. 2 | 3170 | 72 | 6 |
| | Comp. B) 1% | | | |
| | Impact-resistant resins | | | |
| | according to the prior art | | | |
| | (comparative) | | | |
| 7_{comp} | Mix Ex. 2/MPD 89/11 | 2950 | 66 | 10 |
| 8_{comp} | Mix Ex. 2/MPD 58/42 | 1940 | 44 | 40 |

TABLE 2
Mechanical properties determined on injection molded dumb-
bell specimens (ISO 294, 3167) obtained by grains prepared
by extrusion of the compositions shown in the Table

| | Composition | Flexural | Charpy | Charpy |
|---|---|---|---|---|
| | ratios weight/weight | modulus | unnotch. | notched |
| Ex | Mix = mixture | MPa | KJ/m² | KJ/m² |
| 2_{comp} | Acrylic thermoplastic | 3250 | 16 | 1.4 |
| | resin (comparative) | | | |
| 3a | Composition according | 2960 | 19 | 1.4 |
| | to the invention | | | |
| | comp. B): 5% | | | |
| 4 | Mix Ex. 3/Ex. 2 | 2950 | 18 | 1.4 |
| | comp. B: 5% | | | |
| | Impact-resistant resins | | | |
| | according to the | | | |
| | prior art (comparative) | | | |
| 9_{comp} | Mix Ex. 2/MPD 85/15 | 2550 | 30 | 2.2 |
| 10_{comp} | Mix Ex. 2/MPD 75/25 | 2300 | 39 | 3.0 |
| 11_{comp} | Mix Ex. 2/MPD 65/35 | 2000 | 45 | 4.0 |
| | Impact-resistant resin | | | |
| | according to the invention | | | |
| | comp. A) + B) + MPD | | | |
| 12 | Mix Ex. 3a/MPD 85/15 | 2600 | 35 | 3.1 |
| 13 | Mix Ex. 3a/MPD 75/25 | 2350 | 45 | 4.6 |
| 14 | Mix Ex. 3a/MPD 65/35 | 2000 | 70 | 5.5 |
| | Impact-resistance resin | | | |
| | according to the invention | | | |
| | comp. A) + B) + MPD + | | | |
| | thermoplastic resin | | | |
| 15 | Mix Ex. 4/MPD 85/15 | 2650 | 36 | 3.1 |
| 16 | Mix Ex. 4/MPD 75/25 | 2350 | 46 | 4.5 |
| 17 | Mix Ex. 4/MPD 65/35 | 2000 | 70 | 5.5 |
| 19 | Mix Ex. 18/MPD 85/15 | 2600 | 35 | 3.1 |
| 20 | Mix Ex. 18/MPD 75/25 | 2340 | 45 | 4.6 |
| 21 | Mix Ex. 18/MPD 65/35 | 2000 | 71 | 5.4 |

1. Compositions of acrylic polymers comprising:
A) from 70% to 99.5% by weight, preferably from 80% to 99%, still more preferably from 90% to 98% by weight, of a thermoplastic resin based on homopolymers or copolymers formed by monomers containing only one double bond polymerizable by radical route, of which at least 20% by weight, preferably at least 50%, are (meth)acrylic monomers,
b) from 0.5% to 30% by weight, preferably from 1% to 20%, still more preferably from 2% to 10% by weight of an elastomer preferably crosslinked, having an on-set glass transition temperature (Tg) (ASTM D 3418-75) lower than 0° C., preferably lower than −5° C., still more preferably lower than −10° C.,
in said composition the component b) being dispersed in the resin a) under the form of spherical and/or elongated particles, the diameter of particle b), determined by electronic microscopy (tem transmission electronic microscopy), in the range of about 10 nm-2,000 nm, in the case of elongated particles the diameter being that of a transversal section perpendicular to the main axis, the particles of component B) optionally including particles of component A).

2. Compositions according to claim 1, wherein the particles of component B), when including component A), have sizes generally in the range 300 nm-2,000 nm and the particles of component A) included in B) have a diameter, determined as above mentioned, generally lower than 200 nm.

3. Compositions according to claims 1-2, obtainable by extrusion.

4. Compositions according to claims 1-3, wherein the monomer or the mixture of (co)monomers usable for component A), containing one double bond polymerizable by radical route, are (meth)acrylic acids or their alkyl or hydroxyalkyl esters, wherein the alkyl radical has from 1 to 8 carbon atoms, or their amides.

5. Compositions according to claims 1-4, wherein to the monomer of component A) or to the mixture of the (co)monomers of component A) another monomer having only one double bond polymerizable by radical route is added in an amount not higher than 80% by weight, preferably not higher than 50%.

6. Compositions according to claims 1-5, wherein the acrylic (co)polymers of component A) are those containing at least 70% by weight of methylmethacrylate, preferably PMMA and the copolymers of methylmethacrylate with (meth)-acrylic acids or their esters, preferably ethyl or methyl or butyl acrylate or (meth)acrylic acid.

7. Compositions according to claims 1-6, wherein the elastomers to be used as component B) are those obtainable by polymerizing one or more (co)monomers selected from the following groups:
acrylic acid esters wherein the alkyl group has from 1 to 16 carbon atoms, preferably from 2 to 12 carbon atoms,
alkoxy-alkyl acrylates, wherein the total number of the carbon atoms of the alkyl group and the alkoxyl group is in the range 2-16, preferably 3-15,
monomers having double ethylene unsaturation,
vinyl monomers, said monomers in an amount not higher than 40% by weight, preferably not higher than 30% by weight based on the total of the monomers of component B).

8. Compositions according to claims 1-7, wherein the component B) contains crosslinking comonomers comprising at least two double bonds, in amounts in the range 0-2%, preferably 0-1% by weight with respect to the total amount of the monomers of component B).

9. Compositions according to claim 8, wherein the component B) can contain in an amount in the range 0-2% crosslinking monomers containing a polar group.

10. Compositions according to claims 1-9, wherein the elastomer B) has a refractive index in the range 98-102%, preferably 99-101% with respect to that of the thermoplastic resin A).

11. Compositions according to claim 10, wherein the refractive indexes of the components A) and B) are equal.

12. Compositions obtainable by compounding the compositions of claims 1-11 with thermoplastic polymers with the proviso that the percentage of elastomer B) is in the range of about 0.5% and about 30% by weight, preferably of about 1% and about 20% by weight, still more preferably of about 2% and about 10% by weight with respect to the total of the composition.

13. A process for preparing the compositions according to claims 1-11, comprising a polymerization process in suspension for the formation of beads and subsequent compounding of the so obtained beads.

14. A process according to claim 14, wherein the suspension process for obtaining the beads comprises at least the following steps:
1) preparation of beads of elastomer B) by a polymerization process in suspension of the monomers, optionally in the presence of at least one crosslinking monomer as defined in claims 8 and 9;
2) polymerization in the same polymerization suspension containing the formed beads of elastomer B) obtained in step 1), of the (co)monomers forming the thermoplastic polymer A).

15. A process according to claims 13-14, wherein the elastomer component B) contains esters of the acrylic acid wherein the alkyl has a number of carbon atoms equal to or higher than 4, or crosslinking monomers containing at least two double bonds.

16. A process according to claims 13-15, wherein the polymerization is carried out in aqueous suspension in the presence of a radical initiator soluble in the monomers and of a suspending agent for stabilizing the suspension.

17. A process according to claim 16, wherein the suspending agent is selected from the following:
homopolymers of a compound of formula 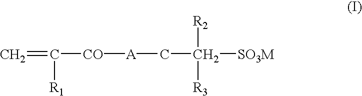
wherein R₁=H or CH₃; R₂ and R₃, equal or different, are H or C₁-C₈ alkyls optionally branched when possible; M is an alkaline or alkaline-earth metal or ammonium and A is NH, oxygen or NCH₃,
copolymers of the compound of formula I with acrylic monomers in an amount not higher than 40% by weight.

18. A process according to claims 16-17, wherein the suspending agent amount is in the range 0.1-1.5%, preferably 0.2-1% by weight, referred to the total weight of the aqueous phase.

19. A process according to claims 16-18, wherein the aqueous polymerization phase is at least partially formed by mother liquors obtained by a polymerization suspension process of a monomer polymerizable by radical route, preferably an acrylic monomer, even different from those used in the process.

20. A process according to claim 19, wherein the dry residue of said mother liquors is in the range 0.05-5% by weight, preferably 0.05-1.5%.

21. A process according to claims 13-20, wherein the bead compounding is carried out by extrusion.

22. Compositions obtainable by compounding the compositions according to claims 1-12 with impact-resistant additives.

23. Compositions according to claim 22, wherein the impact-resistant additive amount is in the range 10-50% by weight, preferably 15-45% by weight, the remaining part being formed by the composition according to claims 1-12, comprising the components A) and B), optionally added with one or more thermoplastic polymers, provided that the elastomer B) in the remaining part is in the range 0.5%-30% by weight, preferably 1-20%, still more preferably 2-10% by weight.

24. Manufactured articles obtainable by the compositions of claims 1-12 and 22-23, preferably flat plates, pipes and section bars.
